(19) United States
(12) Patent Application Publication
(10) Pub. No.: US 2016/0380401 A1
(43) Pub. Date: Dec. 29, 2016

(54) Lubricating method

(71) Applicant: Dean Coley Thommes, Kalamazoo, MI (US)

(72) Inventor: Dean Coley Thommes, Kalamazoo, MI (US)

(21) Appl. No.: 14/545,840

(22) Filed: Jun. 27, 2015

(51) Int. Cl. H01R 43/00; F21V 15/00; F21V 19/00

(52) U.S. Cl. CPC H01R 43/002; H01R 43/005; F21V 19/00; F21V 15/00

(57) ABSTRACT

A method of coating and installing electrical connectors into a receptacle employing a handheld container filled with an open cell, microcellular foam saturated with a liquid lubricant, especially where the electrical connectors are in the base of a CFL light bulb.

This application (1) claims the benefit of provisional application No. 61/488,024 filed May 19, 2011, the specification thereof being incorporated herein by reference and (2) is a continuation-in-part of patent application Ser. No. 13/506,684 filed May 9, 2012.

### FIELD OF INVENTION

This invention relates to a method of lubricating electrical connectors of an electrical appliance to facilitate the installation and removal of the electrical connectors of the electrical appliance into and out of a receptacle adapted to receive the electrical connectors using a handheld container filled with a microcellular, open-celled foam. The method facilitates the passing of electrical current from corresponding connections in the receptacle to the appliance using a fluid electrically non-conducting long lasting lubricant.

### BACKGROUND OF INVENTION

Compact fluorescent light bulbs (CFL) contain small amounts of mercury, a known toxicant. When such a bulb sticks and breaks upon removal from a socket, most likely to occur after a long period of use, the extensive clean up guidelines issued from the Environmental Protection Agency (EPA) and manufacturers to prevent contamination and exposure to the mercury contained in such bulbs are substantial. EPA's instructions for cleaning a broken CFL include four steps before cleanup, seven steps for cleaning hard surfaces, six steps for cleaning carpeting or rugs, and two more steps for future cleaning of carpeting or rugs. Minimizing the possibility of such a cleanup was the stimulus for the present invention.

Sweeping up a broken CFL is much more extensive than sweeping⁻up a shattered incandescent bulb but both cleanups are inconvenient and pose some danger from broken glass itself. While cleanup in either case is not overwhelming, it is desirable to avoid it if it can be done conveniently and inexpensively. The method of the present invention helps to solve this problem by utilizing a device for easy coating of the base of a bulb before it is installed. The method lubricates and conditions the light bulb base, helps to ease the installation and removal of light bulb and, most importantly, minimizes the possibility of breakage most commonly associated with seized light bulb bases in sockets resulting from corrosion between the two metals making the connection. It accomplishes all this by lubricating action and providing a non-conducting, moisture and oxygen displacing barrier between the metal male and female surfaces of the connectors and the sockets into which the connectors are fitted. Most especially, the combination of oxygen and electrical current causes oxidation and corrosion that makes it more difficult to remove a light bulb, especially with the passage of time.

A patent search including electric plug lubricators, light bulb base lubricators, electric outlet lubricators, lubricating devices, lubrication applicators and lubrication devices found the following U.S. patents and one published patent application: U.S. Pat. Nos. 1,421,681; 2,367,721; 2,404,052; 2,430,731; 2,680,449; 3,012,109; 3,642,098; 4,023,648; 5,205,378; 5,181,585; 6,070,697; 6,247,555; and 2006/0173405. None of the foregoing patents disclose a method of making and using a product remotely similar to the method of the present invention, much less as convenient or economical to practice. None disclose the application of a liquid lubricant directly to the base of a light bulb or electrical connectors generally.

The above-identified provisional application was preceded by design patents U.S. D614,574 and D633,870 with the same inventor as the present application but are directed to an ornamental design which is not suitable as pictured for lubricating the base of a light bulb, albeit the D633,870 patent does state that the design is for “a electric plug and light bulb base lubricator”. However the openings in the top surface of the design are not suitable for lubricating a light bulb base. Moreover it does not disclose the other critical features of the present invention as claimed, all of which in combination are necessary features of the present invention as will be disclosed and claimed hereinafter.

The prior art cited in previous Office actions in the parent application of the present continuation to the extent pertinent to the presently claimed invention includes Farone US 2008/0242157 [disclosing an outer layer of non-conductive lubricant material (illustratively WD-40) on the base of a light bulb to reduce corrosion that takes place over an extended period of time]; Parnell U.S. Pat. No. 5,743,359 [disclosing a lubricating tool adapted to hold in one hand including a casing containing a resilient medium (such as polyurethane foam) within the casing with slits radially extending from a pilot hole at the center of the medium and a pressurized lubricant (such as grease) supply passage through the resilient medium from the in the side of the casing to the pilot hole to coat threaded articles (such as bolts)]; Giampaolo U.S. Pat. No. 5,639,310 [disclosing a method of applying a fluid treating agent (such as a cleanser or a disinfectant solution) to articles (such as an earring post or a fingertip) inserted into open celled polyurethane foam containing applicators]; Nadella et al US 2009/0309250 discloses “foaming of plastic materials and, more specifically, to methods and pressure vessels for solid-state microcellular processing of thermoplastic rolls, sheets or films.”; Sigler U.S. Pat. No. 5,722,537 discloses a method for applying a fluid treating agent to articles from slit foam filled containers having a snap on hinged lid with an opposing tab. An important consideration in determining whether the presently claimed invention is obvious over these references is resolving the level of ordinary skill in the pertinent art, one of the four steps to determine obviousness spelled out by the Supreme Court in Graham v. John Deere, the seminal guide for determining obviousness. The Patent Office is necessarily staffed with Examiners of at least ordinary skill in various arts and has established a classification system that identifies various arts to which those Examiners are assigned. An examination of the arts in which the cited references were classified and the fields of search carried out by the Examiners who examined those patents or applications demonstrates that they do not fall in the same field of art. In other words the cited references are classified in different arts and there is no overlap between those arts or the fields of search carried out by the Examiners who examined those applications. This is at least a prima facie evidence that those references would not be evident to one of ordinary skill pertinent to the determination of the obviousness of the present invention. A person of ordinary skill appropriate for the determination of obviousness of the present invention would have to be skilled in the lubricant art (to choose the right lubricant), the electrical art (to avoid short circuits), the chemical art (to know what causes corrosion and how to correct it), the plastic art (to choose the right foam) and the handheld delivery system art (to choose the right container).

### SUMMARY OF INVENTION

The present invention relates to a method of lubricating, installing and removing electrical connecters to and from receptacles. The method is most advantageous when the electrical connector is the base of a CFL light bulb to avoid breakage when removed from the receptacle. In every contemplated use the method makes it easier to install and remove the electrical connectors of light bulbs or plugs without causing short circuits. The method employs a hand held cup filled with a microcellular, open-celled foam saturated with a electrically non-conductive, stable, liquid lubricant, the foam having cross sectional relief cuts in the top that are deep enough to enclose and coat the electrical connectors evenly when immersed and turned in the cuts. The handheld container is small enough to hold in one hand while inserting a light bulb base into the foam with the other hand. A handheld container shaped like a cup is preferred. The foam must be open-celled and microcellular to achieve maximum saturation with the lubricant. The lubricant is preferably a liquid petroleum derivative that is stable over long periods of time while maintaining maximum electrical contact between the surfaces of a receptacle and the electrical connectors. The lubricant must be compatible with the surfaces of the electrical connecter and the receptacle. The cuts in the top surface of the foam are preferably two in number and arranged to cross at right angles to each other at their midpoints. A hole, smaller than the base of a light bulb, can be provided at the point where the cuts would cross each other to facilitate entry of the base into the foam while providing enough tension on the base to facilitate application of the lubricant. Such cuts having a hole where they intersect are generally suitable for most electrical connectors, such as those at both ends of long fluorescent bulbs, the base of refrigerator bulbs or common electric plugs.

A preferred embodiment employs a cup containing foam saturated with a liquid lubricant, the foam sized to fit snugly inside the cup, the cup made of plastic and having a lid with a living hinge opposing a tab to facilitate opening the lid. The liquid lubricant has a viscosity, stability and non-conductivity to coat electrical conductors with a thin layer of lubricant that facilitates connection and removal of the connectors after a long period of time without causing a short circuit. A user would pop the lid using the tab, insert the base of a bulb into relief cuts in the top surface of the foam, turn the bulb to coat the base of the bulb evenly, and remove the bulb ready for insertion of the base into a socket. The relief cuts are preferably two in number, intersect each other at their midpoints and sized to enable a user to insert electrical connectors, like those in a light bulb base, and coat it with a liquid lubricant. A small hole at the intersection can further ease the connectors into the foam. The foam is a microcellular, open cell polyurethane The lubricant is preferably a petroleum derivative like mineral oil.

In summary the present invention is a method of lubricating electrical connecters of an electrical appliance to facilitate the installation and removal of the electrical connectors of the electrical appliance into and out of a receptacle adapted to receive the electrical connectors and facilitate the passing of electrical current from corresponding connections in the receptacle to the appliance using a handheld container filled with a microcellular, open-celled foam, the method comprising the steps of
a) Filling the handheld container with the foam having cross sectional cuts in the top of the foam, the cuts being deep enough to enclose the electrical connectors when immersed in the foam,
b) Saturating the foam from the top of the handheld container with a liquid lubricant fluid enough to saturate the foam, coat and lubricate the electrical connectors evenly with a thin long lasting layer of the liquid lubricant without significantly interfering with the flow of electrical current from the receptacle to the electrical connectors and provide a barrier that prevents oxidation and/or corrosion between the electrical connectors and the receptacle or a short circuit from occurring between the electrical connectors or between an electrical connector and the receptacle,
c) Immersing and turning the electrical connectors in the foam until a thin layer of the liquid lubricant is applied evenly to the entire surface of the electrical connectors and
d) Removing the electrical connectors from the device.

### BRIEF DESCRIPTION OF DRAWINGS

FIG. 1 is a side view of a plastic cup shaped container.

FIG. 2 is a top view of an open container.

FIG. 3 is a top view of the foam showing another version of the relief cuts in the top of the foam.

FIG. 4 is a side view of the container without the attached lid showing an outline of the foam inside the container.

FIG. 5 is a side view of the container with a CFL light bulb pressed into the foam inside the container.

### LIST OF REFERENCE NUMERALS

1 Cup

2 Lid

3 Living hinge

4 Tab

5 Label

6 Foam

7 Relief cuts

8 Hole at the intersection of the cuts

9 CFL light bulb

10 Light bulb base

11 Foam

### DETAILED DESCRIPTION

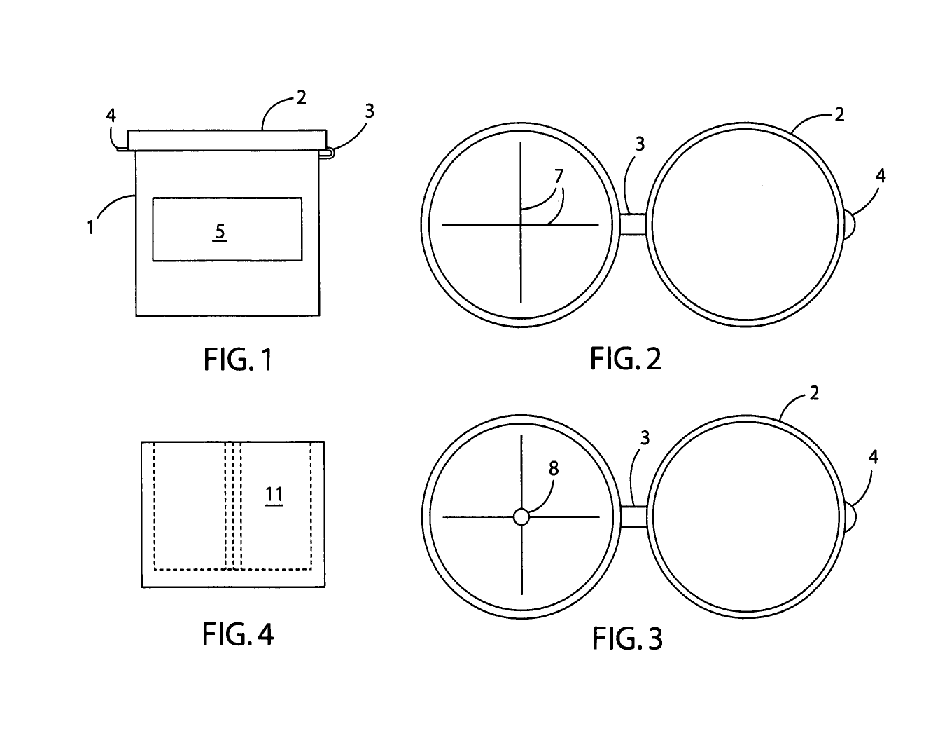

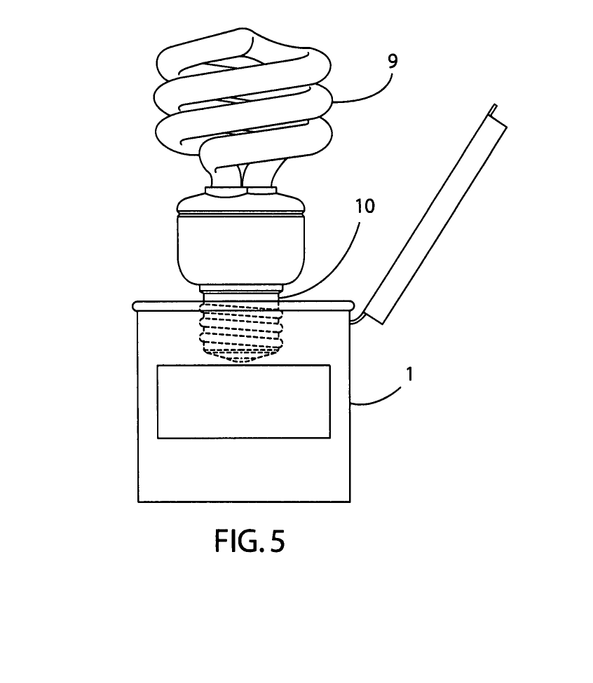

FIG. 1 is a side view of a preferred embodiment of the invention wherein the container is a 2¼ inch plastic cup 1 with a leak proof lid 2 with a sealable living hinge 3 on top opposing a tab 4 to facilitate opening the cup. FIG. 2 is a top view of an open cup 1 showing relief cuts 7 in the foam that fills the container 1. FIG. 3 is a top view of the foam showing relief cuts 7 positioned to cross each other at their midpoints with an added hole or opening 8 where the crossing would otherwise take place for use when the electrical connection to be coated is larger than an ordinary appliance. The added hole 8 and the exact shape of the relief cuts 7 are individually preferred embodiments of the relief cuts but not essential features of the present invention. FIG. 4 is a side of the container 1 without a lid and shows an outline of the foam 11 and the hole in the center of the foam 11. FIG. 5 depicts a CFL light bulb 9 with its base 10 inserted into the container 1. Other electrical connectors can also be inserted and coated with lubricant. The preferred foam 11 is open cell microcellular polyurethane foam. Such a lubricant provides a long lasting coating and is a nonconductor of electricity.

Any environmentally compatible liquid electrical connections lubricant with the fluidity and electrical non-conductivity of mineral oil can be used in the product of the present invention. The most thoroughly evaluated and therefore preferred lubricant is USP White Mineral Oil having 150 VG Grade viscosity of 15 measured by the ASTM D 445 method at 40 degrees C. It is more stable and does not evaporate like mineral spirits or WD 40 which is 50% mineral spirits. It is nontoxic enough to be suitable for use in the food and pharmaceutical industries, an important characteristic for a product intended for consumer use.

The container 1 is preferably a leak proof plastic compatible with the lubricant and foam being used. A convenient size and shape for a hand held container is a cup 1 with a diameter and height of 55 millimeters. The cup 1 can be molded in one piece or extruded in, or cut from, sheets into separate pieces and reassembled by standard procedures well known to those skilled in the manufacturing arts. The user can insert the base 10 of a light bulb 9 into the opening 8 of the cup 1 into the relief cuts 7 in the foam 6 and turn the bulb 9 to coat the base 10 with lubricant.

The foam can be filled from the top of the cup with a liquid lubricant using a large syringe or, for larger quantities, a machine produced by Fisher Scientific identified as a FH100DX Dispensing Pump System. The machine can deliver flow rates between 0.5 to 4,000 ml/min depending upon tubing size. The fluid contacts only the tubing, no valves are employed. Tubing and tube materials employed in the present method are suitable for food and pharmaceutical use. The pump dispenses the lubricant into each cup at the rate of one ounce per cup. This quantity of lubricant can lubricate from about 200 to 300 light bulbs.

When a light bulb base is screwed into a socket, the metal to metal connection between the base and the socket forces the mineral oil away and leaves only a thin layer of oil between and along the outer edges of the surfaces involved. The mineral oil acts as a barrier preventing oxygen or moisture from reaching the contacting surfaces. In doing so it reduces oxidation and the corrosion that leads to sticking and breakage when the light bulb is removed from the socket. The thin layer of oil is also non-conductive enough to prevent short circuits between the electrical terminals involved. Yet it is not so thick that it materially inhibits the passage of electrical current from the socket to the light bulb. The thin layer of oil is also still sufficient and long lasting enough (e.g., prevents corrosion and does not evaporate) to facilitate removal of the bulb after it burns out. This combination of advantages is possessed most impressively by the mineral oil employed in the most preferred method of the present invention.

Although the advantages of present method are most prominent when coating the base of compact fluorescent light (CFL) bulbs due to their mercury content and the possibility of breakage upon removal, it can also be used advantageously to coat any electrical connecter, such as the prongs of long fluorescent light bulbs, three pronged electrical plugs and incandescent light bulbs.

The foregoing provides both a general description of the present invention as well as a specific description of preferred embodiments. It should be understood that various substitutions, variations and modifications can be made by those skilled in the art without departing from the spirit and scope of the invention as further delineated in the following claims.

1. A method of lubricating electrical connecters of an electrical appliance to facilitate the installation and removal of the electrical connectors of the electrical appliance into and out of a receptacle adapted to receive the electrical connectors and facilitate the passing of electrical current from corresponding connections in the receptacle to the appliance using a handheld container filled with a microcellular, open-celled foam, the method comprising the steps of
e) Filling the handheld container with the foam having cross sectional cuts in the top of the foam, the cuts being deep enough to enclose the electrical connectors when immersed in the foam,
f) Saturating the foam from the top of the handheld container with a liquid lubricant fluid enough to saturate the foam, coat and lubricate the electrical connectors evenly with a thin long lasting layer of the liquid lubricant without significantly interfering with the flow of electrical current from the receptacle to the electrical connectors and provide a barrier that prevents oxidation and/or corrosion between the electrical connectors and the receptacle or a short circuit from occurring between the electrical connectors or between an electrical connector and the receptacle,
g) Immersing and turning the electrical connectors in the foam until a thin layer of the liquid lubricant is applied evenly to the entire surface of the electrical connectors and
h) Removing the electrical connectors from the device.

2. The method of claim 1 further comprising the step of easily and conveniently connecting and later removing the electrical connectors to and from a receptacle adapted to provide electrical current to the electrical connectors.

3. The method of claim 1 further comprising the electrical connectors are located in a light bulb base and the receptacle is a female socket adapted to receive the light bulb base with matching electrical connections.

4. The method of claim 3 further comprising the light bulb is a CFL light bulb.

5. The method of claim 3 further comprising the cross sectional cuts are suitable in size and shape for applying lubricant to the entire base of the light bulb.

6. The method of claim 1 further comprising the liquid lubricant is mineral oil.

7. The method of claim 6 further comprising the liquid lubricant is mineral oil having a 150 VG grade viscosity of about 15 measured by the ASTM D 445 method.

8. The method of claim 1 further comprising the handheld container is made of a leak proof plastic and shaped like a cup having a top connected to a snap on lid by a living hinge, the lid having a tab opposite the hinge to facilitate opening and closing the lid.

9. The method of claim 1 further comprising the relief cuts are two in number, centrally located in the top surface to the bottom of the foam and intersect each other at their midpoints.

10. The method of claim 9 further comprising a hole is present at the midpoints of the two cuts.

11. The method of claim 1 further comprising the foam is polyurethane.

12. A method of lubricating a base of a light bulb that comprises the steps of inserting the base of the light bulb into
a. a container adapted to hold in one hand,
b. a microcellular open cell foam filling the container,
c. a stable, nontoxic, liquid lubricant saturating the foam, and
d. relief cuts in the top surface of the foam adapted to coat an electrical connector and
turning the light bulb in the foam until the base is saturated with the liquid lubricant.

13. The method of claim 12 further comprising the container is a leak proof plastic shaped cup connected to a snap on lid by with a living hinge, the lid having a tab opposite the hinge to facilitate opening the lid.

14. The method of claim 12 further comprising a microcellular open cell high density polyurethane foam.

15. The method of claim 12 further comprising the base of a light bulb is threaded to fit a standard light bulb socket.
